(19) United States
(12) Patent Application Publication
(10) Pub. No.: US 2019/0059410 A1
(43) Pub. Date: Feb. 28, 2019

(54) APPARATUS AND METHODS FOR REMOVING CAFFEINE FROM BREWED, CAFFEINATED COFFEE

(71) Applicants: James J. Farley, Savannah, GA (US); Alan R. Tripp, Bryn Mawr, PA (US)

(72) Inventors: James J. Farley, Savannah, GA (US); Alan R. Tripp, Bryn Mawr, PA (US)

(21) Appl. No.: 16/172,823

(22) Filed: Oct. 28, 2018

Related U.S. Application Data
(63) Continuation of application No. 15/485,292, filed on Apr. 12, 2017.
Application No. 15/485,292 is a continuation-in-part of application No. 15/288,143, filed on Oct. 7, 2016.
Application No. 15/288,143 is a continuation of application No. 13/099,456, filed on May 3, 2011, now abandoned.

(51) Int. Cl. A23F 5/22; A47J 31/00; A47J 31/44

(52) U.S. Cl. CPC A23F 5/223; A47J 31/002; A47J 31/4471; A47J 31/44

(57) ABSTRACT

A system and method for reducing the amount of caffeine in an existing volume of brewed coffee. The brewed coffee contains a predetermined level of caffeine. To reduce the caffeine, a caffeine filter is provided. Furthermore, a coffee receptacle is provided to hold the decaffeinated coffee. A filter chamber is positioned over the coffee receptacle. The caffeine filter is placed in the filter chamber. Brewed coffee is dripped, poured, or otherwise advanced into the filter chamber. At least some of the brewed coffee flows through the caffeine filter and into the coffee receptacle. This reduces the level of caffeine of the filtered coffee entering the coffee receptacle. The system also enables a single source of brewed coffee to produce cups of both regular coffee and decaffeinated coffee, using only one type of regular ground coffee.

### REFERENCE TO RELATED APPLICATION

This application is a continuation of U.S. patent application Ser. No. 15/485,292, filed Apr. 12, 2017, which is a continuation-in-part of U.S. patent application Ser. No. 15/288,143, filed Oct. 7, 2016, which is a continuation of U.S. patent application Ser. No. 13/099,456, filed May 3, 2011, the entire content of each application being incorporated herein by reference.

### FIELD OF THE INVENTION

In general, the present invention relates to coffee makers that are used to brew either a cup or a pot of coffee. Additionally, the present invention relates to systems and methods that are used to remove caffeine from brewed coffee.

### BACKGROUND OF THE INVENTION

Many people like to drink freshly brewed coffee. Of those people, some like to drink regular caffeinated coffee, while others prefer to drink decaffeinated coffee. As a consequence, when a group of people are gathered, separate pots of regular coffee and decaffeinated coffee need to be brewed in order to accommodate the different preferences of coffee drinkers.

In many homes, people brew coffee using a coffeemaker. Some of the most popular coffee makers are drip coffee makers. In a drip coffee maker, ground coffee is placed in a filter cone above a pot. The coffee maker heats water and then directs the heated water through the filter cone. The water brews the coffee and the coffee drips through the filter and into the awaiting pot. Many people only have a single coffee maker. Consequently, if a person wants to serve both regular coffee and decaffeinated coffee, two separate pots of coffee must be brewed. Furthermore, once one type of coffee is brewed, the coffee must be transferred to some secondary serving pot, so that the coffee machine pot is available for use in making the second type of coffee.

In the prior art, attempts have been made to solve this problem by creating caffeine filtering packets that are placed into a coffee cup. As regular coffee is poured into a coffee cup, the caffeine in the coffee is partially removed by the filter packet. Such prior art systems are exemplified by U.S. Pat. No. 5,603,830 to Everhart, entitled Caffeine Adsorbent Liquid Filter With Integrated Adsorbent. The problem with such prior art filter packets is one of effectiveness. Coffee is brewed at the temperature of boiling water. As soon as the coffee is brewed, it begins to cool. The coffee starts to cool as soon as it drips into the coffee pot. The coffee further cools as it is poured through the air and into a cold coffee cup. Furthermore, the coffee cools even more as it saturates the cold filter packet. As the coffee cools it loses significant energy. As a result, the cooled coffee in cup must sit with a filter packet for up to two minutes, to remove a mere 40 percent of the caffeine in the coffee.

Many people do not want to wait to drink their coffee. Furthermore, many people do not consider coffee that still has sixty-percent of its caffeine to be decaffeinated.

In the prior art, attempts have been made to remove caffeine from coffee when it is at its hottest temperature. This is typically done by creating a coffee filter that also is a caffeine filter. Such a prior art system is exemplified by U.S. Pat. No. 2,375,550 to Grossman, entitled Removal of Caffeine From Coffee Extract.

The problem with such filters is one of flow rate. Drip coffee makers need thin porous coffee filters in order to achieve the proper flow rate of coffee through the filter. If the filter is too thick, or otherwise too dense, the coffee will back up in the filter and overflow out of the coffee maker. When a caffeine filter is added to the coffee filter, it must be made very thin in order to maintain the required coffee flow through rate. However, making a caffeine filter so thin, severely limits its effectiveness. As a consequence, still less than half of the caffeine in the coffee is removed.

Another problem associated with combining a caffeine filter with a coffee filter is that the caffeine filter affects all of the coffee that passes through the filter. Consequently, a person can create a pot of partially decaffeinated coffee, but they still have to brew a pot of regular coffee if both regular and decaffeinated coffee are to be served. Furthermore, since the entire pot of coffee is decaffeinated by the filter, it is more efficient just to simply use decaffeinated coffee to start. A need therefore exists for a coffee maker that brews caffeinated coffee and yet can remove at least 50% and up to 90% percent of the caffeine from the brewed coffee before it is served. A need also exists for a coffee maker that can make a single brew of coffee and produce individual servings of either regular coffee or decaffeinated coffee from that single brew. These needs are met by the present invention as described and claimed below.

### SUMMARY OF THE INVENTION

The present invention is a system and method for reducing the amount of caffeine in an existing volume of brewed coffee. The brewed coffee, by nature, contains a predetermined level of caffeine. To reduce this level of caffeine, a caffeine filter is provided. Furthermore, a coffee receptacle, such as a coffee cup or a coffee pot is provided to hold the decaffeinated coffee.

A filter chamber is positioned over the coffee receptacle. The caffeine filter is placed in the filter chamber. Brewed coffee is dripped, poured, or otherwise advanced into the filter chamber. At least some of the brewed coffee is directed through the caffeine filter and into the coffee receptacle. This reduces the level of caffeine of the filtered coffee filling the coffee receptacle. The system also enables a single source of brewed coffee to produce cups of both regular coffee and decaffeinated coffee, using only one type of regular ground coffee.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a perspective view of an exemplary embodiment of a coffee maker machine;

FIG. 2 is a schematic of the operational features of the coffee maker machine shown in FIG. 1;

FIG. 3 is a schematic of an alternate embodiment of a coffee maker machine;

FIG. 4 is a perspective view of an alternate embodiment of the present invention;

FIG. 5 is a perspective view of an alternate embodiment of the present invention;

FIG. 6 is a high-performance liquid chromatography (HPLC) curve for standard caffeine;

FIG. 7 is a high-performance liquid chromatography (HPLC) curve for regular coffee;

FIG. 8 is a high-performance liquid chromatography (HPLC) curve for Calgon Type TOG-NDG-LF-5 in fine powder form;

FIG. 9 is a high-performance liquid chromatography (HPLC) curve for Norit GA830 in granular form;

FIG. 10 is a high-performance liquid chromatography (HPLC) curve for Norit GAC1240 in granular form; and

FIG. 11 is a high-performance liquid chromatography (HPLC) curve for Norit PAC200 in fine powder form.

### DETAILED DESCRIPTION OF THE INVENTION

Although the present invention assembly and method can be embodied in many ways, the embodiments illustrated show the assembly configured as a drip coffee maker for in-home use. These embodiments are selected in order to set forth the best modes contemplated for the invention. The illustrated embodiments, however, are merely exemplary and should not be considered limitations when interpreting the scope of the appended claims.

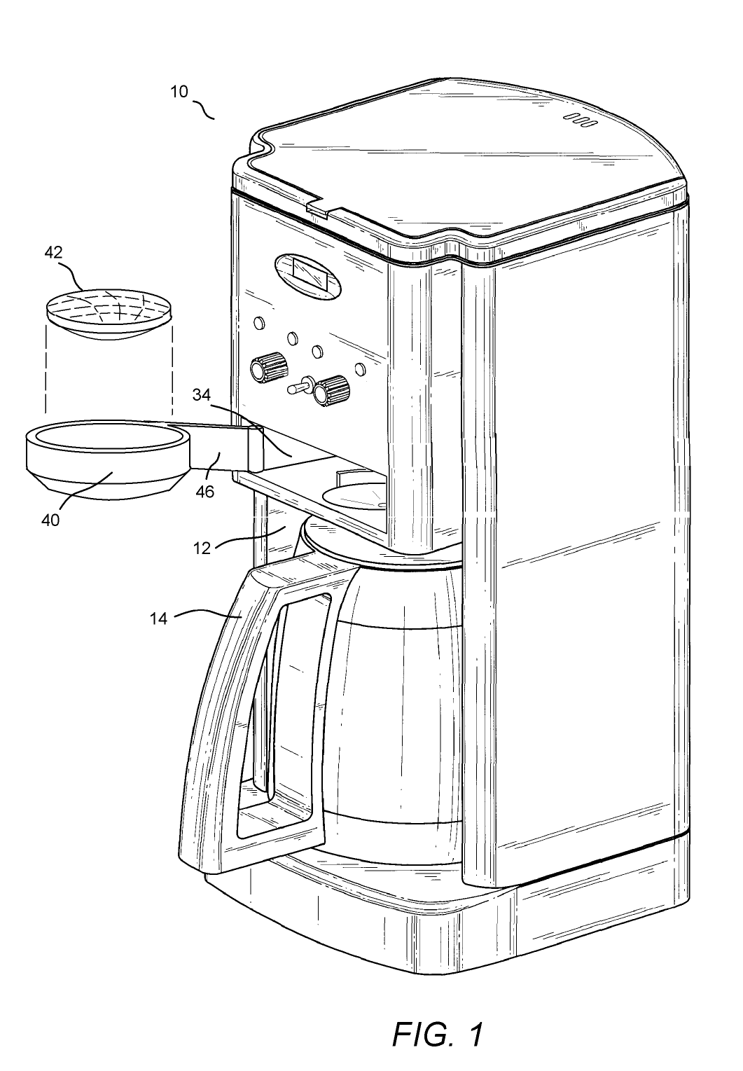

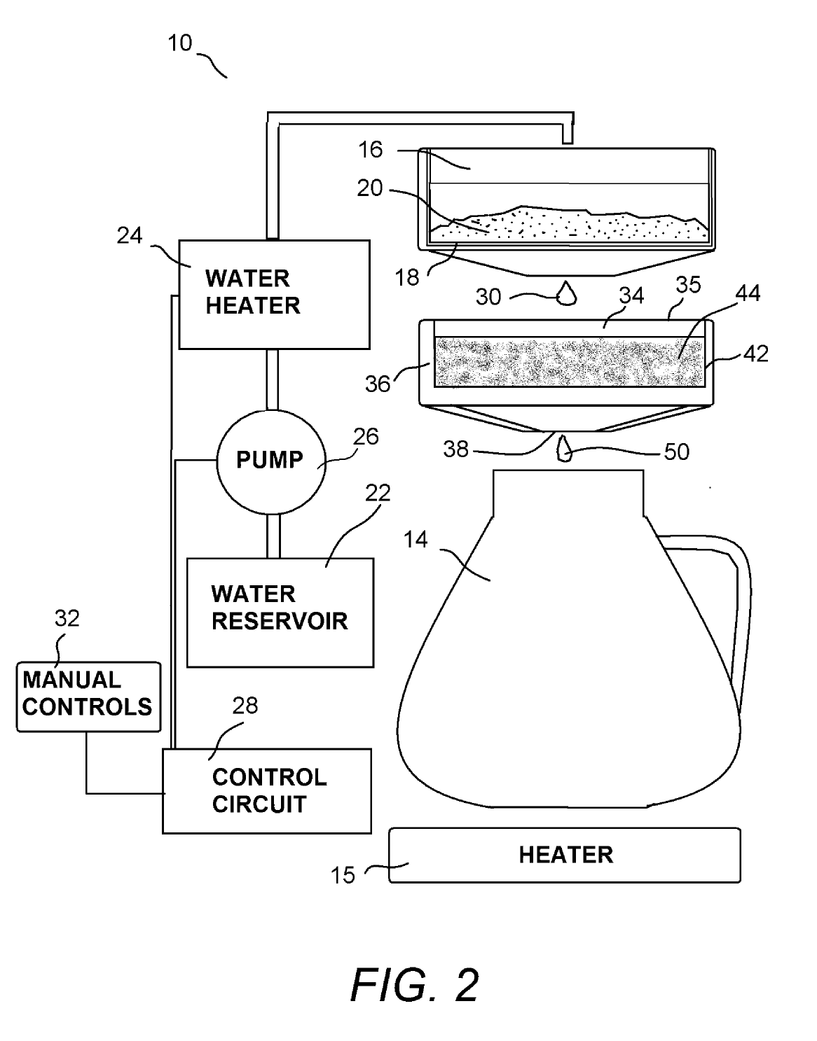

Referring to both FIGS. 1 and 2, a drip coffee maker 10 is shown. The coffee maker 10 has a receptacle port 12 sized to receive a coffee pot 14. Within the receptacle port 12, a heater 15 is provided to heat the contents of the coffee pot 14.

A brew chamber 16 is positioned at the top of the coffee maker 10 above the receptacle port 12 and the coffee pot 14. A traditional prior art coffee filter 18 is placed in the brew chamber 16. The coffee filter 18 is partially filled with regular caffeinated ground coffee 20. The ground coffee 20 contains caffeine, as is the case with natural coffee. A water reservoir 22, water heater 24 and water pump 26 are provided. The water heater 24 heats some of the water from the water reservoir 22 to a temperature just below boiling. The heated water is pumped into the brew chamber 16, wherein the water brews the ground coffee 20 to produce brewed coffee 30. The brewed coffee 30 permeates through the coffee filter 18. The water pump 26 and the water heater 24 are managed by a control circuit 28. The control circuit 28 is set by a user interacting with the various manual controls 32, in the form of buttons and knobs manufactured into the coffee maker 10. In this manner, the coffee maker 10 can be set to brew one cup, two cups or any number of cups up to the capacity of the coffee pot 14.

If regular coffee is desired, the brewed coffee 30 passing through the coffee filter 18 is permitted to drip directly into the coffee pot 14. The coffee pot 14 will therefore fill with regular caffeinated coffee. However, if decaffeinated coffee is desired, an auxiliary filter system is provided.

A filter chamber 34 is provided below the brew chamber 16 and above the coffee pot 14. The filter chamber 34 has a large open top 35 that receives the brewed coffee 30 dripping out of the brew chamber 16. The brewed chamber 16 has side walls 36 that funnel the brewed coffee 30 to a narrow flow opening 38 at the bottom of the filter chamber 34. Accordingly, any brewed coffee 30 that drips into the open top 35 of the filter chamber 34 is funneled to the flow opening 38 at the bottom of the filter chamber 34.

A filter support structure 40 is formed within the filter chamber 34. The filter support structure 40 is configured to receive and retain a removable caffeine filter 42. When the caffeine filter 42 is placed in the filter support structure 40, all the brewed coffee 30 that flows through the filter chamber 34 is directed through the caffeine filter 42. The caffeine filter 42 is a premanufactured packet that contains activated charcoal and/or other material that interacts with the caffeine present within the brewed coffee 30 or adsorbs the caffeine.

The shape of the filter 42 may be varied in accordance with the shape of the filter holder and/or the desired amount of time that the caffeinated coffee is exposed to the activated charcoal or adsorbant. Thus, the filter may be pad-shaped with a single peripheral seam or puck-shaped with one or more peripheral seams. The thickness of the filter may be in the range of 0.25 to 2 inches, again, depending upon the shape of the filter holder and/or the desired amount of time that the caffeinated coffee is exposed to the activated charcoal or adsorbant. The peripheral shape of the filter may be round, oval, square or any operative shape. The activated charcoal or adsorbant may be embedded into a funnel shape with an inner filter, an outer filter, and the charcoal or adsorbant disposed therebetween. The filter “paper” may be natural or synthetic, with the porosity of the material being selected as a function of grain size. That is, for a granular material, the porosity may be greater than a material used in conjunction with a fine powder to minimize the amount of activated charcoal or adsorbant escaping from the filter as the caffeinated coffee flows therethrough.

The amount of activated charcoal or adsorbant in the filter is also a function of the amount of caffeinated coffee to be decaffeinated and the desired level of decaffeination. In preferred embodiments, the caffeine filter 42 contains an amount of activated charcoal 44 in the range of 1 to 10 grams. In more preferred embodiments, the caffeine filter 42 contains at least five grams. Much larger amounts of activated charcoal 44, in the range of 10 to 100 grams can be used to decaffeinate large pots of coffee. Although the primary function of the caffeine filter 42 is to remove caffeine from the brewed coffee 30, the caffeine filter 42 may contain other ingredients that add material to the brewed coffee 30. For example, flavorants may be provided in the caffeine filter 42 that add flavors, such as vanilla or cinnamon to the brewed coffee 30.

The rate of flow out of the brew chamber 16 is known by the manufacturer of the coffee maker 10. For many traditional coffee makers, this flow rate is between 0.05 and 0.5 fluid ounces per second. The size of the filter chamber 34 and the porosity of the caffeine filter 42 are designed so that the flow rate through the filter chamber 34 and the caffeine filter 42 is greater than the flow rate out of the brew chamber 16. In this manner, when the coffee maker 10 is in operation, the flow out of the brew chamber 16 cannot cause the underlying filter chamber 34 to overflow.

The caffeine filter 42 is selectively inserted into, and removed from, the filter chamber 34. When the caffeine filter 42 is not in place, the brewed coffee 30 flows through the empty filter chamber 34 and filter support structure 40 without being altered. However, when the caffeine filter 42 is in place, all the brewed coffee 30 flowing into the coffee pot 14 passes through the caffeine filter 42. The filter support structure 40 has a swivel arm 46 that is pivotably connected to the coffee maker 10. As a result, the filter support structure 40 can be selectively moved between an operational position and a loading position. When the filter support structure 40 is in its loading position, it is pivoted out of the filter chamber 34 so that the caffeine filter 42 is accessible and easy to both load and unload. When the pivoting retainer is moved to its operational position, the filter support structure 40 holds the caffeine filter 42 in position within the filter chamber 34.

It will be understood that the brewed coffee 30 is at its hottest in the coffee maker 10 while the brewed coffee 30 is first made in the brew chamber 16. By positioning the caffeine filter 42 directly under the brew chamber 16, the caffeine filter 42 receives the brewed coffee 30 before the brewed coffee 30 has had the ability to cool to any significant degree. As a result, the brewed coffee 30 interacts with the caffeine filter 42 while at or near its brewing temperature and reaches the coffee pot with minimum loss of temperature. Furthermore, since the brewed coffee 30 is dripping through the caffeine filter 42 at a rate controlled by gravity, the caffeine filter 42 never becomes overwhelmed by the volume of brewed coffee 30. The result is that all of the brewed coffee 30 passes through the caffeine filter 42. None of the brewed coffee 30 flows around the caffeine filter 42 without being affected. As a consequence, over ninety percent of the caffeine contained within the brewed coffee 30 can be removed by the caffeine filter 42.

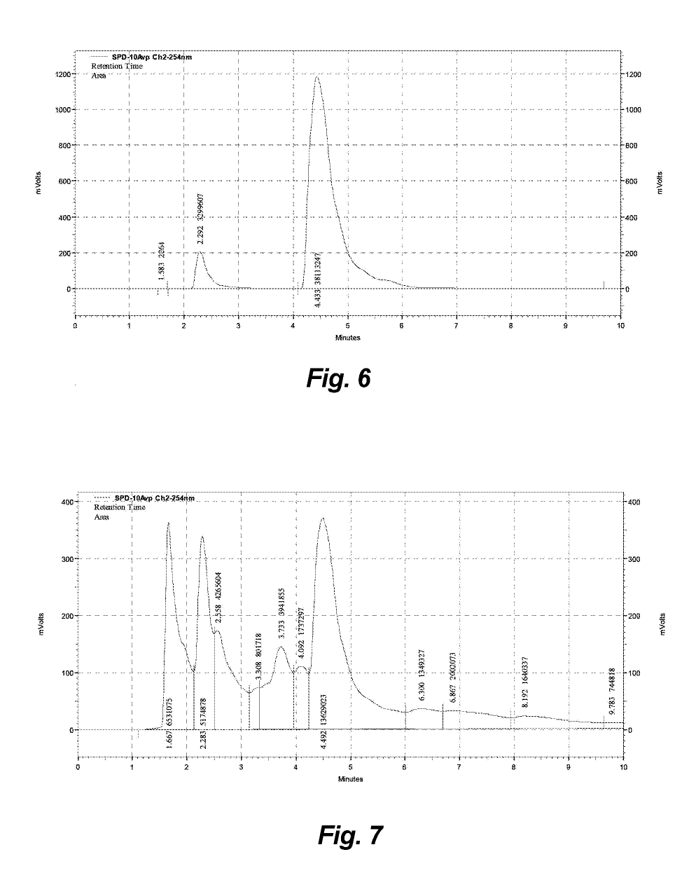

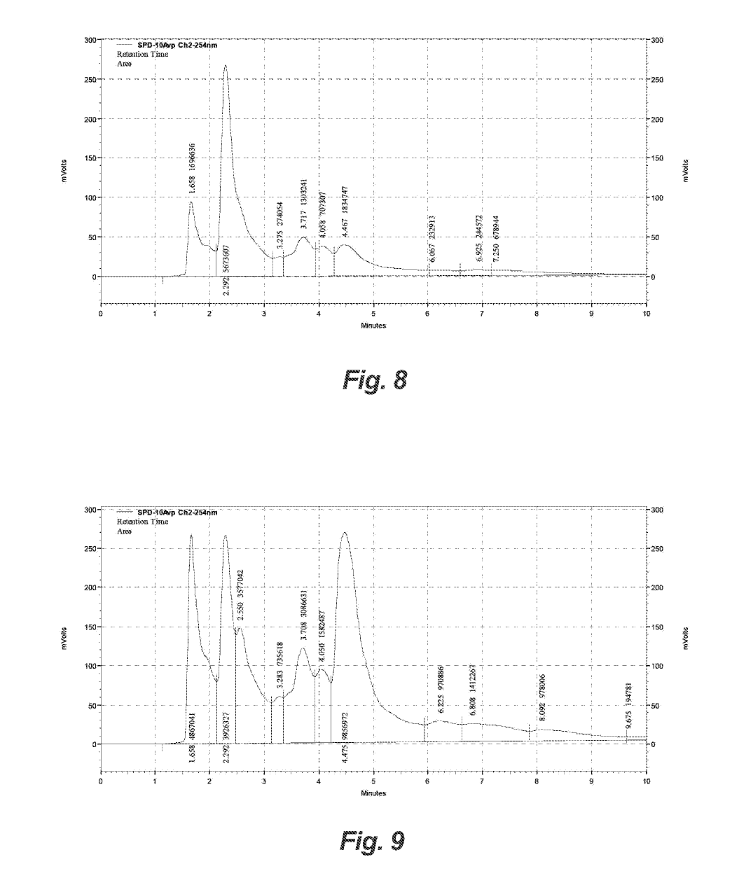

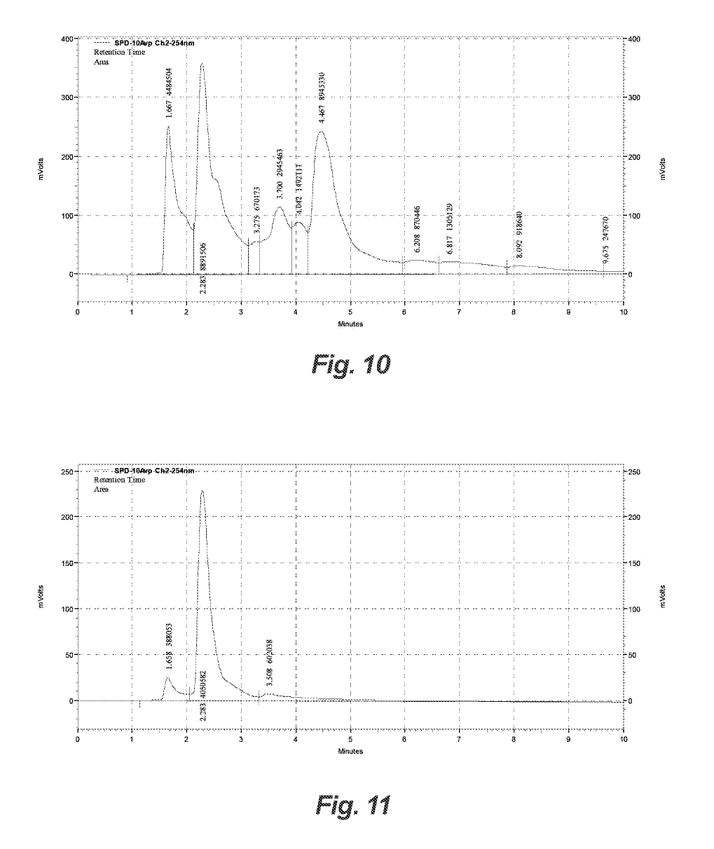

To determine the effectiveness of commercially available caffeine adsorbants, experiments were conducted using high-performance liquid chromatography (HPLC). FIGS. 6 through 11 show, respectively, HPLC curves for standard caffeine; regular coffee; Calgon Type TOG-NDG-LF-5 in fine powder form; Norit GA830 in granular form; Norit GAC1240 in granular form; and Norit PAC200 in fine powder form. This study shows while that granular activated carbon may not be that effective, activated carbon in fine powder form of highly effective in removing caffeine from regular coffee in a short period of time.

The experimental procedures were as follows:
1) Blank: brew 4 cups (˜636 mL) of water through coffee maker with white filter paper.
2) Brew (˜2×7.4 g) of coffee using 4 cups of water (˜636 mL), with white filter paper.
3) A small amount of brewed coffee was injected into HPLC to determine its initial caffeine content.
4) Pour 150 mL hot coffee (50° C.) over 5 g activated carbon in one-layer white Whatman #40 filter paper (150 mm, Catalog #1440-150) in a funnel Filter paper.
5) About 1 mL of the filtrate was further centrifuged to precipitate the activated carbon.
6) The clear solution was injected into HPLC to determine caffeine content.
7) HPLC conditions: 25% MeOH+75% water, flow rate 1.0 mL/min, 254 nm, 15 cm C18 column. Caffeine retention time 4.3 min.

The results were as follows:

| | Initial | Final | % of |
|---|---|---|---|
| | Caffeine | Caffeine | Caffeine |
| Run | Content | Content | Removal |
| 1) Regular coffee | 3.22 mM | — | — |
| 2) Calgon Type TOG-NDG-LF-5 | 3.22 mM | 0.43 mM | 87% |
| (Fine powder) | | | |
| 3) Norit GA830 (Granular) | 3.22 mM | 2.33 mM | 28% |
| 4) Norit GAC 1240 (Granular) | 3.22 mM | 2.11 mM | 34% |
| 5) Norit PAC 200 (Fine powder) | 3.22 mM | 0.14 mM | 96% |

In operation, if a person wants to make a pot of regular caffeinated coffee, the caffeine filter 42 can be removed and the coffee maker 10 would operate in the traditional manner using standard ground coffee 20 and standard coffee filters 18. Conversely, if a person wants to make a pot of decaffeinated coffee, regular ground coffee 20 can be placed into the brew chamber 16. The caffeine filter 42 is set into its operational position within the filter chamber 34. The coffee maker 10 is then operated in the traditional fashion. The brewed coffee 30 drips out of the brew chamber 16 and into the filter chamber 34. In the filter chamber 34, the brewed coffee 30 passes through the caffeine filter 42 and loses up to ninety percent of its caffeine, depending upon the filter used. The decaffeinated filtered coffee 50 then drips into the coffee pot 14.

It will also be understood that the coffee maker 10 can be filled with enough coffee to make two or more cups of coffee. The manual controls 32 can then be set to brew coffee one cup serving at a time. A coffee cup can be set in place of the coffee pot 14. The first cup of coffee can be brewed without the caffeine filter 42 in place. Subsequent cups of coffee can then be brewed with the caffeine filter 42 in place. As a result, by filling a coffee maker 10 with regular ground coffee only once, cups of both regular caffeinated coffee and decaffeinated coffee can be selectively brewed.

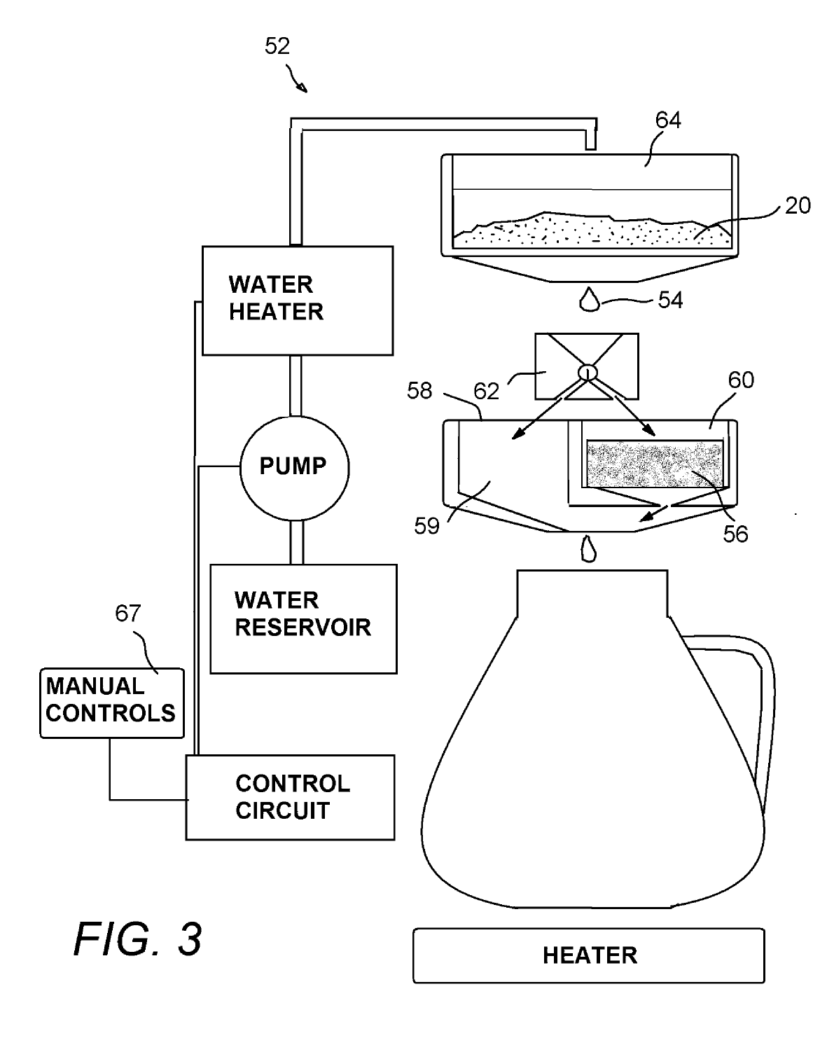

Referring now to FIG. 3, an alternate embodiment of the present invention coffee maker 52 is shown. In this embodiment, the coffee maker 52 is capable of changing the flow of brewed coffee 54 along one of two possible paths. In the first path, the brewed coffee 54 does not pass through a caffeine filter 56 and remains caffeinated. In the second path, the brewed coffee 54 passes through a caffeine filter 56 and becomes decaffeinated.

In this embodiment, a filter chamber 58 is provided that is partitioned into an open section 59 and a filtered section 60. Nothing is present in the open section 59. Accordingly, any coffee flowing through the open section 59 would pass straight through the filter chamber 58 unaffected. Conversely, the caffeine filter 56 is positioned in the filtered section 60. Consequently, any brewed coffee 54 that passes into the filtered section 60 would pass through the caffeine filter 56 and would therefore be decaffeinated.

A deflector mechanism 62 is provided under the brew chamber 64. The deflector mechanism 62 is controlled by at least one of the manual controls 67. The deflector mechanism 62 can be used to selectively direct the brewed coffee 54 into either the open section 59 or the filtered section 60 of the filter chamber 58. In this manner, a person can brew a cup or pot of decaffeinated coffee and then a cup or pot of regular coffee without having to add or remove any caffeine filter. The user need only push the proper button on the coffee maker 52.

It will therefore be understood that a caffeine filter 56 can be loaded into the coffee maker 52 at the beginning of a day. Prior to use, the caffeine filter 56 is wrapped in a protective package to prevent the caffeine filter 56 from interacting with gases in the air. The packaging is removed just prior to placing the caffeine filter 56 into the coffee maker 52. Regular ground coffee 20 is filled into the brew chamber 64. If a person wants regular coffee, that person does nothing but operate the coffee maker 52 in the traditional manner. If a person wants decaffeinated coffee, that person presses the appropriate “decaffeinated” button on the use interface. This changes the position of the deflector mechanism 62 and directs the brewed coffee 54 through the caffeine filter 56. Decaffeinated coffee is then obtained.

A single caffeine filter 56 can be made large enough to filter caffeine from multiple cups or pots of coffee. In this manner, a single caffeine filter 56 can be used to decaffeinate different cups or pots of coffee that are brewed at different times. However, for best decaffeination control, it is preferred that single use caffeine filter be used and that the caffeine filter be discarded after every use.

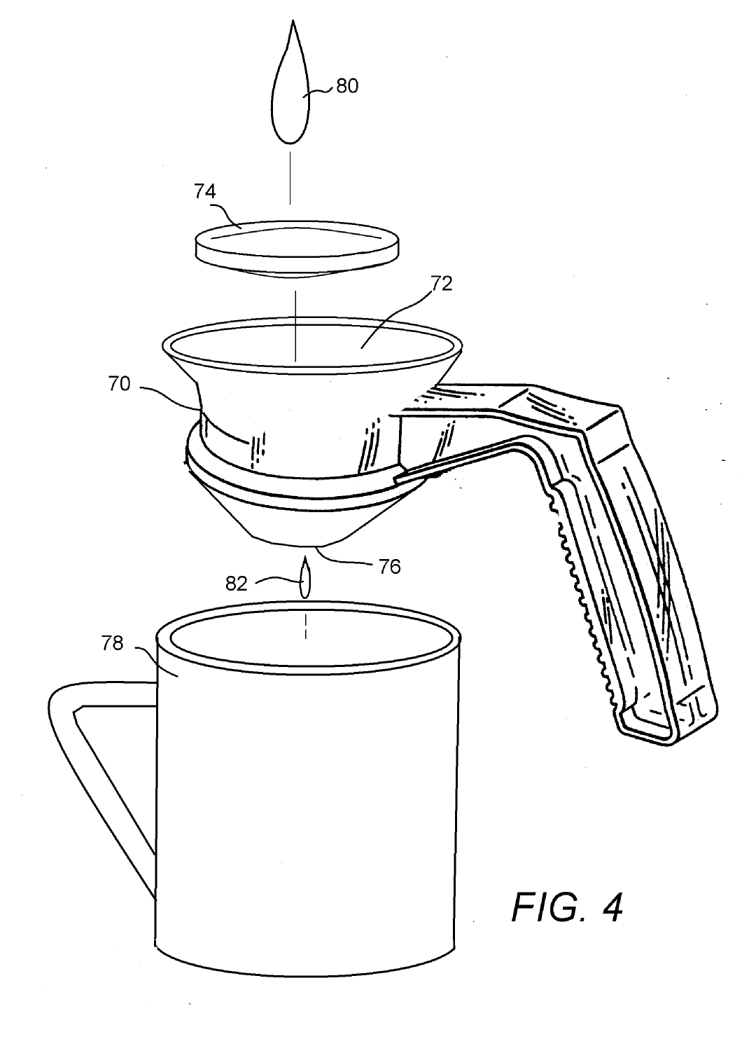

Referring to FIG. 4, another embodiment of the present invention is shown. In this embodiment, the filter chamber and caffeine filter are removed from a coffee maker and are embodied in a handheld assembly 70. The handheld assembly 70 contains a funnel shaped filter chamber 72. A caffeine filter 74 is placed within the filter chamber 72. A flow opening 76 is formed in the bottom of the filter chamber 72 below the caffeine filter 74. The handheld assembly 70 is held over a coffee cup 78 so that the flow opening 76 is positioned over the coffee cup 78. Brewed caffeinated coffee 80 is poured into the filter chamber 72. The brewed coffee 80 flows through the caffeine filter 74 where most of the caffeine is removed. The filtered decaffeinated coffee 82 then flows into the coffee cup 78 through the flow opening 76. Once the desired amount of filtered coffee 82 has flowed into the coffee cup 78, the handheld assembly 70 is removed.

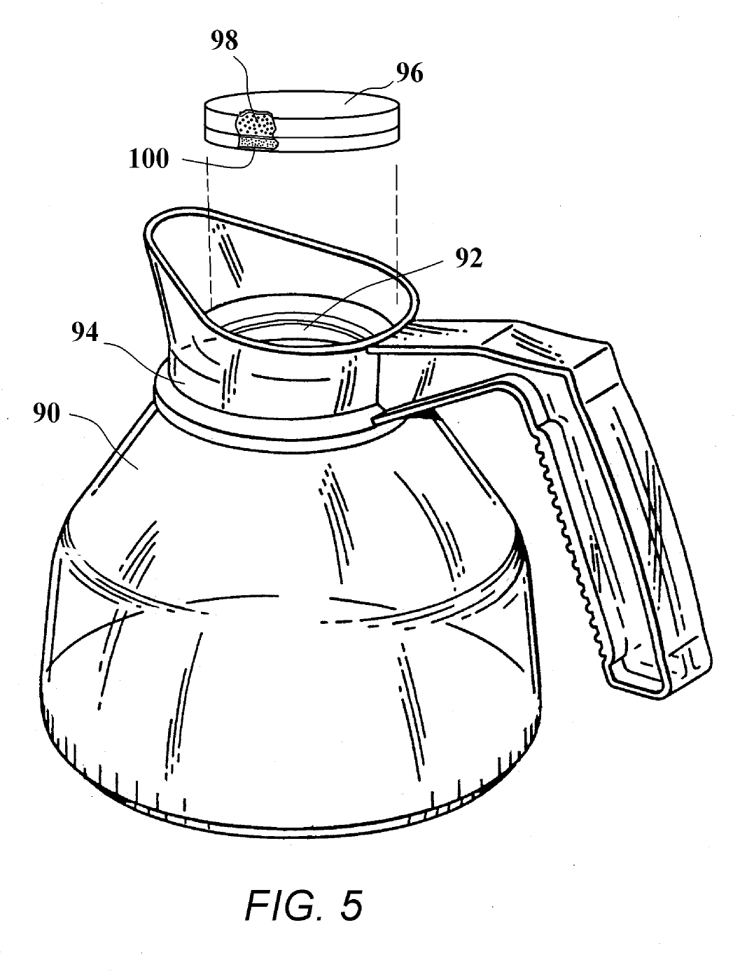

Referring to FIG. 5, yet another embodiment of the present invention is shown. In this embodiment, a filter chamber 92 is designed into the neck 94 of a coffee pot 90. The filter chamber 92 is shaped and sized to receive and retain a removable filter packet 96.

In the shown embodiment, the filter packet 96 contains two different compounds. In the top of the filter packet 96 is a volume of activated charcoal 98. The activated charcoal 98 adsorbs caffeine, as has been previously described. Accordingly, it will be understood that when the filter packet 96 is in place, the activated charcoal 98 will adsorb caffeine from brewed coffee, both as the brewed coffee is dripped into the coffee pot 90 and as the brewed coffee is poured out of the coffee pot 90. The caffeine filtration of the coffee both entering and leaving the coffee pot 90 increases the effectiveness of the caffeine removal. This results in coffee that is highly decaffeinated when finally poured into a cup.

The second compound in the filter packet 96 is a flavorant 100. The flavorant 100 adds a secondary flavor to the brewed coffee as the brewed coffee flows into and out of the coffee pot 90. In this manner, different flavors can be added to different pots of coffee, even though only one type of coffee is being brewed.

It will be understood that the filter packet 96 can contain only activated charcoal 98 or only flavorant 100, and that the showing of both is only a convenience for this disclosure.

It will be understood that the embodiments of the present invention that are illustrated and described are merely exemplary and that a person skilled in the art can make many variations to those embodiments. All such embodiments are intended to be included within the scope of the present invention as defined by the claims.

1. A filter for decaffeinating brewed, caffeinated coffee, comprising:
a single-use filter packet constructed of filter material having a porosity;
wherein the filter packet has upper and lower layers of filter material entirely enclosing an interior volume, and wherein the filter packet has a predetermined shape and size to be removably received by an existing filter holder; and
at least five grams of powdered caffeine adsorbing activated charcoal contained in the interior volume of the filter packet, and wherein the caffeine adsorbing material is separate from the layers of filter material of the single-use packet;
whereby, when brewed, caffeinated coffee is poured through the single-use filter packet, at least 90% of the caffeine is removed from the brewed coffee by the at least five grams of powdered caffeine adsorbing activated charcoal contained in the filter packet;
wherein the powdered caffeine-adsorbing activated charcoal contained in the filter packet has a particle size; and
wherein the porosity of the filter material of the filter packet is a function of the particle size.

2. The filter of claim 1, wherein the filter packet further includes a flavorant.

3. The filter of claim 1, wherein the porosity of the filter material is chosen to ensure that all of the brewed, caffeinated coffee flows through the filter packet when received by the existing filter holder.

4. The filter of claim 1, wherein the shape of the filter packet is a round pad.

5. The filter of claim 1, wherein the existing filter holder is a funnel-shaped filter holder.
